(19) United States
(12) Patent Application Publication
(10) Pub. No.: US 2016/0098887 A1
(43) Pub. Date: Apr. 7, 2016

(54) CASINO TABLE WITH CHARITABLE BETTING DISPLAY

(71) Applicant: Seminole Hard Rock Entertainment, Inc., Hollywood, FL (US)

(72) Inventor: Jesse Chavez-Munoz, Dorset (GB)

(73) Assignee: SEMINOLE HARD ROCK ENTERTAINMENT, INC., Hollywood, FL (US)

(21) Appl. No.: 14/868,815

(22) Filed: Sep. 29, 2015

Related U.S. Application Data
(60) Provisional application No. 62/058,184, filed on Oct. 1, 2014.

(51) Int. Cl. G07F 17/32

(52) U.S. Cl. CPC G07F 17/322; G07F 17/3293; G07F 17/3248

(57) ABSTRACT

A charitable betting display system for a casino gaming table including a gaming table surface upon which a casino game involving betting is played, the surface being attached to a gaming table and including a plurality of player positions. Each player position is defined by an image formed on the surface including a bet placement location. A charitable betting display located in close proximity to each bet placement location. The charitable betting display providing indicia representing a particular charity for which a bet will be allocated. In one embodiment the charitable betting display is an electronic display that is controllable for changing the image shown on the charitable betting display. A method of conducting charitable betting is also disclosed.

### RELATED APPLICATION

This application is related to and claims priority from United States Provisional Application No. 62/058184, filed on Oct. 1, 2014, the disclosure of which is incorporated herein by reference in its entirety.

### FIELD OF THE INVENTION

The invention relates to a unique casino table with an integrated display for facilitating placing bets that are designated for charities.

### BACKGROUND

Current gaming tables, such as blackjack, roulette, craps and baccarat, have designated locations for bets and placement of cards, etc. For example, on a blackjack table, there is typically a square shaped betting box formed on the table top (on the felt) that is located directly in front of the player. The player places his/her bet typically inside the box. The cards that are dealt to the player are generally placed between the box and the dealer.

Periodically, the player may wish to place a bet as a “tip” for the dealer. Although there is no specific location delineated on the table top for such bets, it has become customary on a blackjack table to place such a tip bet on the top right hand corner of the betting box.

Apart from the dealer tip bet, current casino table layouts do not provide a location for placement of a bet to be directed to a charity.

### SUMMARY OF THE INVENTION

The present invention is directed to a charitable betting display system for a casino gaming table including a gaming table surface upon which a casino game involving betting is played. The surface being attached to a gaming table and including a plurality of player positions. Each player position is defined by an image formed on the surface including a bet placement location. A charitable betting display located in close proximity to each bet placement location. The charitable betting display providing indicia representing a particular charity for which a bet will be allocated.

In one embodiment the charitable betting display is an electronic display that is controllable for changing the image shown on the charitable betting display. The electronic display may be an LCD, LED or plasma display.

At least one controller communicates with at least one of the electronic displays for controlling the indicia displayed thereon. In one embodiment, the controller controls all the electronic displays. The controller may include an interface for permitting a user to supply information for controlling the at least one electronic display.

In one embodiment there is a central display on the table surface for displaying information including information related to the charity associated with each charitable display.

A method of charitable betting using the charitable betting display system is also disclosed. The method involves use of a charitable betting display system. An image is displayed representative of a particular charity on each display. At least one gaming chip is placed on or adjacent to one of the displays representing a bet from a player at that position at the table. A round of the particular game is played. At the conclusion of the round, the charitable bet is deposited into a money slot in the table. If the player won the particular round, a corresponding amount or chips from the casino is also placed in the money slot. The amount of all the chips in the money slot are tallied for disbursement to the particular charity.

In one embodiment, there is a central display on the table surface and the method involves displaying information on the central display related to the charity including displaying the amount of the tally.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1 illustrates a blackjack table layout incorporating a charitable display mounted to the tabletop according to one embodiment.

FIG. 2A is an enlargement of a player's position in the blackjack layout of FIG. 1.

FIG. 2B is an enlargement of a player's position in an alternate embodiment of the blackjack layout of FIG. 1.

FIG. 3A is a schematic of a control system for controlling an electronic display system according to an embodiment of the blackjack layout of FIG. 1.

FIG. 3B is a schematic of a control system for controlling an electronic display system according to an alternate embodiment of the blackjack layout of FIG. 1.

### DESCRIPTION OF THE EMBODIMENTS

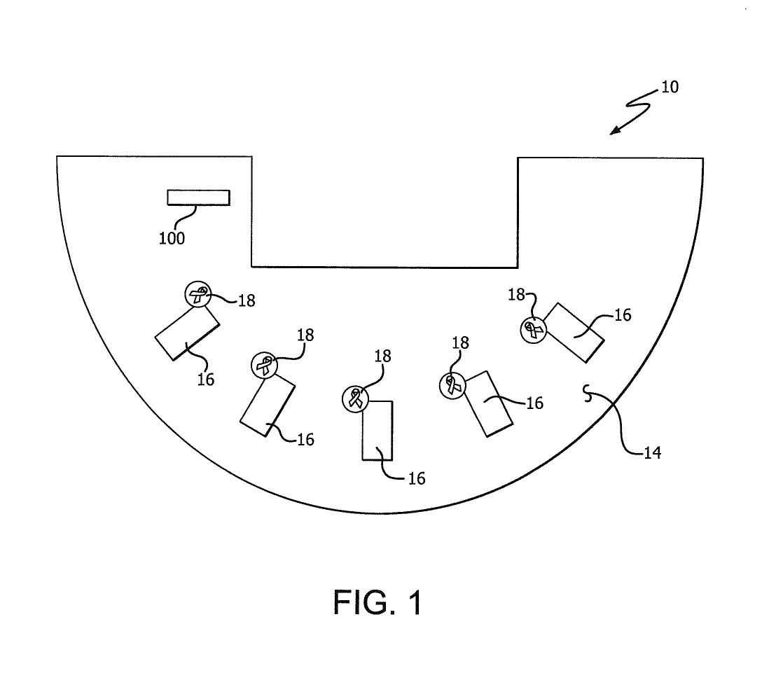

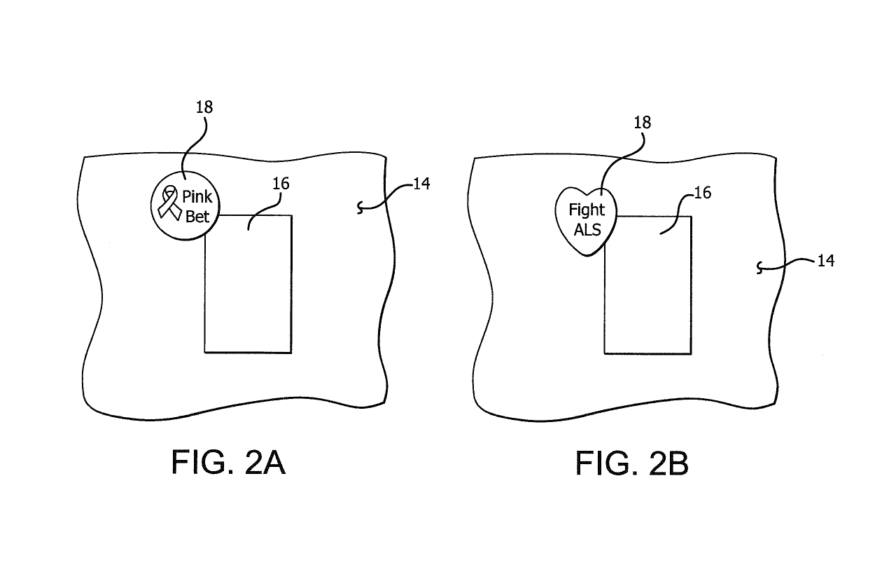

Referring now to the drawings wherein like reference numerals represent corresponding elements throughout the views several embodiments of the present invention are shown. The present invention incorporates a charitable giving or betting aspect to various gaming tables by giving the player the ability to dedicate a certain bet to a specifically named or displayed charity. Referring to FIGS. 1, 2A and 2B, embodiments of the present invention for use in a blackjack table configuration are shown. It should be understood that the present invention can also be incorporated into other table games, including craps and roulette.

As is common in the industry, most gaming tables 10 include a raised table top surface with a playing area or field 14, typically displayed on a felt or similar material that is on the table top surface. The playing area 14 includes betting boxes 16 at defined locations around the player side of the table where players can place bets. Typically bets are placed within the box 16. In one embodiment of the invention, the table playing area 14 incorporates a specific marked charity bet area 18 near each player for placement of a bet that will be considered as being played for a specific charity. In the illustrated embodiment, the location of the charity bet area 18 is in the upper left hand corner as shown. The charity bet area 18 may be a graphic formed on the felt, such as a round spot as shown in FIG. 2A that is includes color, graphical indicia and/or text related to the particular charity being sponsored. To provide a better visualization of the “giving” aspect of the spot, the charity bet area could be shaped in a particular way such as a ribbon or a heart as shown in FIG. 2B. In this embodiment, since the charity bet area 18 is a graphic disposed one the felt top, the felt top would have to be changed out as the charity changes, e.g., monthly, weekly, daily, etc. It is also envisioned that the charity bet area 18 could be an emblem with adhesive on one side that is attached to the existing felt top. As such, the charity displayed in the charity bet area 18 can be changed simply by peeling off the prior emblem and replacing it with a new emblem.

In one preferred embodiment, the charity bet area 18 is an electronic display, such as an LED, LCD or plasma display, that is programmable to provide a graphical display related to a charity or other information. For example, the electronic display may be in the shape of a circle, heart or rectangle located in a similar spot as shown in FIGS. 2A and 2B.

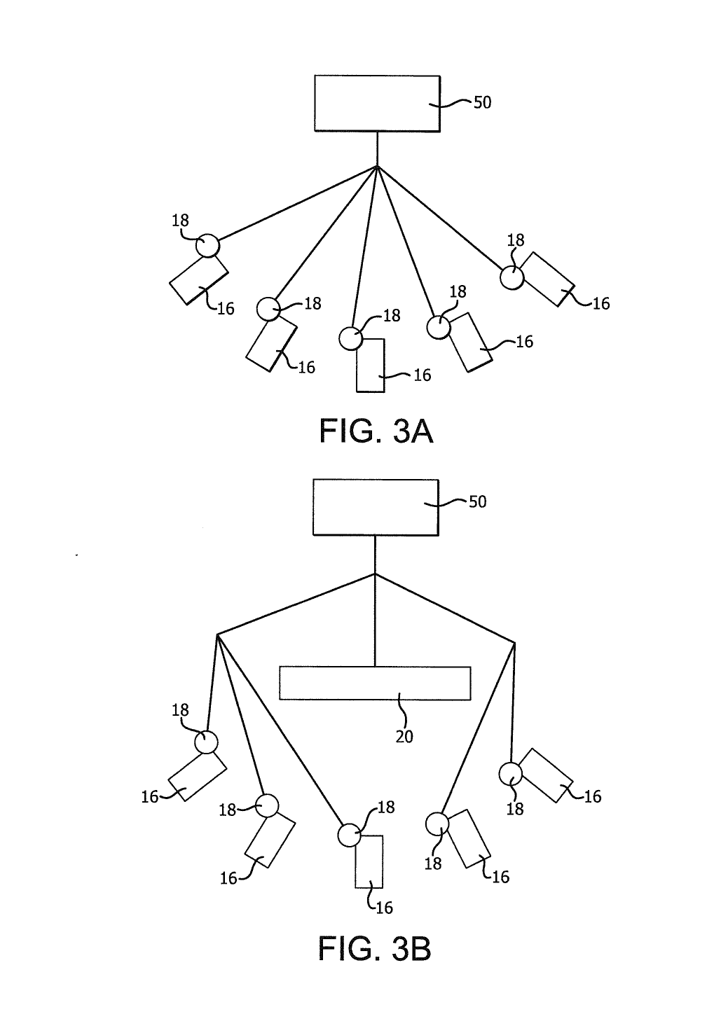

Referring to FIG. 3A, the display 18 on each location on a table 10 preferably is programed to depict varying images related to charities of other information, e.g. “Help Fight ALS”, “Pinktober”, etc. The display 18 is preferably controlled by a controller 50, which includes conventional processing and circuitry that permits entry of the graphical information to be depicted in each display 18, i.e., the name or logo of a particular charity, information on a charity or a disease etc. For example, the controller 50 could be a computer programmed to control the displays and to allow a user to input or import an image, icon, logo, and/or text, such as a pink ribbon and accompanying text, for depicting on each display 18. The input could be through any conventional means, including a flash drive, keyboard or hard wired connection, WiFi upload or any other method for transferred or inputting digital information. The controller 50 preferably includes a data storage for storing the image or information to be depicted and the program code for controlling the displays 18. The controller 15 retrieves the digital image or information to be depicted on each display and transmits the information to the display 18 to visually depict the current charity for which a bet would be allocated. The controller permits the display 18 to be periodically changed, such as daily, weekly or monthly, as the charity is changed.

Preferably the controller 50 is centrally located, such as on a central server that is networked to each table 10, so as to allow for controlling displays 18 on multiple tables 10 through one controller 50. Of course, it is also possible that the controller 50 could be located on each table 10 with the program code either in the controller 50 or in processors (firmware, software, code) associated with each display 18. The controller may include an interface for permitting user to supply information for controlling the electronic display(s). The interface could be a port for receiving a flashdrive for transmitting the data for displaying on the displays. The interface could be a remote computer graphical display that permits a user to select a particular table or display and supply a graphical indicia or program for running on the displays associate with the table. The controller 50 could remotely control the displays through a wired or wireless configuration.

Referring now to FIG. 3B, it is also envisioned that a central electronic display 20 may be incorporated into the table top. The central display 20 could be used to depict more information to the players, such as details on the charity, including how much has been raised so far that month (e.g., “ALS has received $30,000 in table donations today, have you donated?”), how the charitable betting works, etc. The central display 20 may be an LED, LCD or plasma display, that is configured to provide a graphical display. The central display 20 is preferably controlled by a central controller, such as the controller 50, which includes programming code for controlling the central display 20. It is also envisioned that the central display 20 could also depict graphical information (including text information) that is not affiliated with the charity, such as information about the casino (e.g., “Happy hour starts in the casino lounge in 15 minutes.”) or updates on sports events, etc.

Furthermore, it is contemplated that the controller 50 could control all the displays on a table for purposes of attracting players. For example, the controller 50 could be used on tables that have recently opened or that have no players sitting at to cause the displays 18 to depict graphical indicia or select colors and which cycle from one side to the other (e.g., in the embodiment shown in FIG. 1, the cycling could start from the leftmost player position and move to the rightmost player position), thus providing a visual light show to attract players to the table.

One charitable betting process according to the invention would operate as follows. When a player wishes to place a bet to benefit a charity, the player puts one or more chips on the charity bet area 18. The blackjack hand is dealt as would normally be the case. If the bet results in a “win”, the casino pays the bet even money. The dealer takes the player's bet and the casino's payout and places both chips into the “cash drop slot” 100 in the table top. If the bet results in a “loss”, the dealer takes the losing bet and places it in the cash drop slot 100. Since no other chips are dropped down the cash drop slot 100 (only cash is placed in there), when the box is counted, the chips in the box are applied directly to the charity. As such, the present invention provides a win-win for the charity since even losing chips are paid to the charity. Alternately, a separate charity slot could be built into the table to allow the chips to be placed into the designated slot for counting later.

It is also contemplated that an RFID chip or other tracking device or mechanism can be used in the present invention for purposes of tracking the charitable bets. For example, an RFID chip could be incorporated into each casino and an RFID reader could be placed in the cash slot 100 and/or in the charitable bet area 18. The reader could detect the amount of chips that have been allocated to the charity and provide an automatic update to the controller 50. The controller 50 could update the amount that the charity has received from all the tables 10 and display it on the central display 20 or elsewhere. The RFID chip could also be associated with a particular player and, as such, permit the casino to keep track of the amount of charitable bets the player has donated. At any point, the player could request a printout of the amount donated for use by the player for tax purposes.

The system or systems described herein may be implemented on any form of computer or computers. The system of the present invention may include a software program stored on a computer and/or storage device (e.g., mediums), and/or may be executed through a network. The method may be implemented through program code or program modules stored on a storage medium.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail.

Finally, the use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

1. A charitable betting display system for a casino gaming table comprising:
a gaming table surface upon which a casino game involving betting is played, the surface being attached to a gaming table and including a plurality of player positions, each position defined by an image formed on the surface including a bet placement location; and
a charitable betting display located in close proximity to each bet placement location the charitable betting display providing indicia representing a particular charity for which a bet will be allocated.

2. A charitable betting display system according to claim 1, wherein the charitable betting display is an electronic display controllable for changing the image shown on the charitable betting display.

3. A charitable betting display system according to claim 2, wherein the electronic display is an LCD, LED or plasma display.

4. A charitable betting display system according to claim 2, wherein the casino game is blackjack, and wherein the image for each player position is a rectangular box and wherein the electronic display is positioned to the side of the rectangular box or on the opposite side of the rectangular box relative to the player position.

5. A charitable betting display system according to claim 2, further comprising at least one controller, the at least one controller communicating with at least one of the electronic displays for controlling the indicia displayed thereon.

6. A charitable betting display system according to claim 5, wherein the at least one controller controls all the electronic displays.

7. A charitable betting display system according to claim 5, wherein the at least one controller includes an interface for permitting a user to supply information for controlling the at least one electronic display.

8. A charitable betting display system according to claim 2, wherein there is a central display on the table surface for displaying information including information related to the charity associated with each charitable display.

9. A charitable betting display system according to claim 1, wherein the casino game is blackjack, and wherein the image for each player position is a rectangular box and wherein the charitable display is a static display that is disposed on or adhered to the surface at a position to the side of the rectangular box or on the opposite side of the rectangular box relative to the player position.

10. A charitable betting display system for a casino gaming table comprising:
a gaming table surface upon which a casino game involving betting is played, the surface being attached to a gaming table and including a plurality of player positions, each position defined by an image formed on the surface including a bet placement location;
a charitable betting display located in close proximity to each bet placement location, the charitable betting display including an electronic LED, LCD or plasma display for displaying indicia representative of a particular charity for which a bet will be allocated;
a controller communicating with the electronic displays for controlling the indicia displayed on each charitable betting display, the at least one controller including an interface for permitting a user to supply information for controlling the electronic displays.

11. A method of charitable betting on a gaming table at a casino comprising the steps of:
providing a charitable betting display system for a casino gaming table according to claim 1;
displaying an image representative of a particular charity on each display;
receiving at least one gaming chip on or adjacent to one of the displays representing a bet from a player at that position at the table;
playing a round of the particular game;
at the conclusion of the round, placing the bet into a money slot in the table and, if the player won the particular round, placing a corresponding amount or chips from the casino in the money slot; and
tallying the amount of all the chips in the money slot for disbursement to the particular charity.

12. A method of charitable betting according to claim 11, wherein there is a central display on the table surface, the method further providing the step of displaying information related to the charity including displaying the amount of the tally.

13. A method of charitable betting according to claim 11, wherein the charitable betting display is a controllable electronic display, the method further providing the step of controlling the image displayed on the electronic display for altering the charity to which a bet is allocated.

14. A method of charitable betting according to claim 13, further comprising at least one controller communicating with at least one of the electronic displays for controlling the indicia displayed thereon.

15. A method of charitable betting according to claim 14, wherein the at least one controller controls all the electronic displays at a gaming table, and wherein the method involves the step of controlling all the electronic displays so that they each display graphical indicia related to the same charity.

16. A method of charitable betting according to claim 15, wherein the at least one controller includes an interface for permitting a user to supply information for controlling information depicted on the electronic displays, and wherein the method involves the step of inputting data to the electronic interface related to a charity for displaying each of the electronic displays.
